(19) United States
(12) Patent Application Publication
(10) Pub. No.: US 2006/0197063 A1
(43) Pub. Date: Sep. 7, 2006

(54) Shaped porous materials

(76) Inventors: Stephen Robert Tennison, Surrey (GB); Andrew John Blackburn, Hampshire (GB)

Correspondence Address: BEYER WEAVER & THOMAS, LLP, P.O. BOX 70250, OAKLAND, CA, 94612-0250, US

(21) Appl. No.: 10/551,590

(22) PCT Filed: Mar. 29, 2004
(86) PCT No.: PCT/GB04/01413

§ 371 Date: Nov. 10, 2005

(30) Foreign Application Priority Data
Mar. 29, 2003 (GB) 0307332.7

(51) Int. Cl. C04B 35/64; H01B 1/12

(52) U.S. Cl. 252/500; 264/628; 264/642; 264/681

(57) ABSTRACT

A method for forming a complex shaped controlled porosity adsorbent material comprises adding a powdered material such as activated carbon to a partially cured phenolic resin powder forming the mixture into a dough, shaping the dough to obtain a shaped solid product and sintering the shaped solid so as to produce a form-stable sintered product.

The present invention relates to a method for forming a complex shaped controlled porosity adsorbent material.

There are very few viable routes for the production of complex shaped controlled porosity adsorbent materials. For instance activated carbon is traditionally produced by taking a char, made by pyrolysing an organic precursor or coal, grinding the char to a fine powder, mixing this with a binder, typically pitch, and extruding or pressing to give a “green” body. The green body is then further fired to pyrolyse the binder and this is then typically further activated in steam, air, carbon dioxide or mixtures of these gases to give the high surface activated carbon product. The drawback to this route is that the binder, which is usually a thermoplastic material, goes through a melting transition prior to pyrolytic decomposition. At this point the material is weak and unable to support a complex form. This, combined with the problems of activating the fired body, limits the size and shape of the products to typically simple extrudates.

An alternative route is to take an activated carbon powder and form this directly into the final shape. In this instance a range of polymeric binders have been used that remain in the final product. The main drawback to this route is that high levels of binders are required and these then tend to both infill the pores of the activated carbon powder and encapsulate the powder leading to a marked reduction in adsorption capacity and a deterioration in the adsorption kinetics. The presence of the polymeric phase also degrades the physical and chemical stability of the formed material, severely limiting the range of applicability.

A further alternative is to take a formed ceramic material, such as a multichannel monolith, and to coat this with a carbon forming precursor such as a phenolic resin; this can then be fired and activated to produce a ceramic-carbon composite. The main limitations of this route are the cost associated with the ceramic substrate and the relatively low volume loading of carbon. At high degrees of activation it is possible to produce a mesoporous carbon although the carbon volumetric loading and the mechanical stability of the carbon is further reduced.

EP 0 254 551 gives details of methods of forming the porous carbons and its contents are included herein by reference. The process comprises (a) partially curing a phenolic resin to a solid, (b) grinding the solid to form particles, (c) forming the resulting ground product into a dough and extruding to a pre-determined shape at a pressure in the range 0 to 20 MPa, (d) sintering the shaped solid so as to produce a form-stable sintered product. The sintered product can then be activated.

Patent application PCT/GB 2002/003259 discloses an improved method of forming complex carbon forms by sintering partially cured phenolic resin powders. In this route the novolak resin precursor is partially cured using hexamethylene tetramine (Hexamine) to an extent sufficient to just convert the thermoplastic novolak to a thermoset resin. The resin is then milled to a powder with a particle size of between 5 and 500 microns, mixed with an extrusion aid such as methyl cellulose to form a dough, and extruded to produce complex monolith structures which, after drying, can be carbonised and activated. The formed carbons have a very uniform structure, exhibit good thermal and electrical conductivity and can be produced with surface areas up to around 1000 m²/g. The only drawback to this production route is that the phenolic resin derived carbons can only be produced with pores of approximately 0.6-1.0 nm which is too small for many applications.

Patent application PCT/GB01/03560 discloses a method for the production of a meso/macroporous monolithic carbon by using a meso/macroporous phenolic resin, produced according to patent EP 0 254 551, in conjunction with novolak phenolic resin as a binder. It is not possible to produce the meso/macro porous monoliths direct from the meso/macroporous resins of EP 0 254 551 as the high degree of cure required to generate the meso/macro pores prevents the resin particles from sintering.

If, however the porous resin powder is mixed with a powder comprising thermoplastic novolak and hexamine curing agent, and this is then extruded using methocell as an extrusion agent, the material can be dried, carbonised and activated to give a micro/mesoporous carbon monolithic structure. The drawbacks to this route are that the novolak resin binder tends to partially infill the meso/macro pore structure of the cured resin component leading to a reduction in pore volume and that the porous cured resin cannot be produced with pores in the critical 1-5nm pore size range.

We have now devised a method for producing strong, controlled pore structure materials using a mixture of a partially cured resin and a wide range of secondary materials.

According to the invention there is provided a method for producing a porous material which comprises (i) partially curing a phenolic resin to a solid; (ii) grinding the solid to form resin particles; (iii) mixing the resin particles with particles of a secondary component; (iii) forming the mixture into a dough; (iv) shaping the dough to obtain a shaped solid product and (v) sintering the shaped solid so as to produce a form-stable sintered product.

The sintered product can then be activated extruded and dried.

The dough can be shaped by a range of processes e.g. extrusion, pressing, moulding, spray drying etc.

Optionally there can be an additive such as a methyl cellulose which aids in the dough forming or shaping process.

Phenolic resins are well known materials. They are made by the reaction of a phenol and an aldehyde e.g. formaldehyde. The condensation is initially carried out to produce a partially condensed product. The condensation may be carried out so as to produce a resin which is fully curable on further heating. Alternatively the condensation may be carried out so as to produce a novolak resin which is only curable when an additional cross-linking agent is mixed with it e.g. hexamethylene tetramine (known as “hexamine” or “hex”). It is preferred to use hexamine-cured novolak resins in the process of the present invention.

The resin cure should be controlled so that it is sufficient to prevent the resin melting during subsequent carbonisation but low enough that the particles produced during the milling step can sinter during subsequent processing. Preferably the temperature and duration of the partial curing step is selected as to give a degree of cure sufficient to give a sinterable product, and being such that a sample of the partially cured solid when ground to produce particles in the size range 106-250 microns and tabletted in a tabletting machine gives a pellet with a crush strength which is not less than 1 N/mm. Preferably the pellet after carbonisation has a crush strength of not less than 8 N/mm.

Novolak resins are typically produced by the acid catalysed condensation of phenol and formaldehyde in approximately equimolar amounts. Novolaks are usually thermoplastic solid polymers that melt at or above 100° C. depending on the average molecular weight. They are essentially linear chains with molecular weights of from 500 to 2000 D, where phenolic moieties are linked with methylene (predominantly) and methylene ether bridges and possess one nucleophilic active site, predominantly in the unsubstituted ortho-position to hydroxyl group. There can be also varying degrees of chain branching depending upon the production conditions.

Whilst the commercial materials are largely produced using phenol and formaldehyde, a variety of modifying reagents can be used at the pre-polymer formation stage to introduce a range of different oxygen and nitrogen functionality's and cross-linking sites. These include but are not limited to:

1. Hydroquinone and resorcinol. Both are more reactive than phenol and can lead to some cross-linking at the pre-polymer production stage. It is also possible to introduce these compounds at the cross-linking stage to provide different cross-linking paths. These also increase the oxygen functionality of the resins.

2. Nitrogen containing compounds that are active in polycondensation reactions, such as urea, aromatic (aniline) and heteroaromatic (melamine) amines. These allow the introduction of specific types of nitrogen functionality into the initial polymer (and final carbon) and influence the development of the mesoporous structure of both the resins and the final carbons.

Like hydroquinone and resorcinol, all the nitrogen containing nucleophilic modifying reagents which can be used in the present invention possess two or more active sites and are more reactive in condensation reactions than phenol or Novolaks. It means that they are first to react with primary cross-linking agents forming secondary cross-linking agents in situ. In the case of melamine it is preferable to prepare the secondary cross-linking agent—hydroxymethylated melamine—in advance.

Novolaks are thermally stable in that they can be heated and cooled repeatedly without structural change. They are cured on addition of cross-linking agents and heating.

The secondary material can be any powdered solid which is not adversely affected by the sintering process or which interferes unacceptably with the resin. Secondary materials which can be used include, but are not limited to, activated carbon powder, graphite, metals, metal and inorganic oxides and mixtures thereof. In this instance the partially cured resin powder does not act as a binder but rather creates a cage structure that retains the secondary component or components without in any way changing the porosity of the second component.

As the sintered resin structure shrinks substantially during firing (˜40% volume) leading to a reduction in the inter particle pore volume, the volume of the second component, which typically does not shrink during firing, this then limits the amount of the second component that can be tolerated. If the volume of the secondary component exceeds approximately 40% leading to cracking and a marked degradation of the mechanical properties of the composite, through the use of different secondary components it is then possible to produce complex shaped materials with a wide range of complex adsorption, catalytic and physical properties.

The second material can also be the mesoporous resin beads produced according to patent application PCT/GB01/03560. Whilst we have shown that it is not possible to produce monoliths direct from these beads, and the use of uncured novolak resin leads to a significant loss in pore volume, a binary mixture can be produced from the cured resin powder combined with the beads that can then be formed to produce a strong monolithic structure. In contrast to the structures made with inorganic or powdered carbon additives, much higher loadings of the mesoporous resin beads can be used. These shrink to a similar extent to the cured Novolak powder during carbonisation and this avoids the problems of cracking experienced with the other materials.

The secondary component can be selected according to the modification to be obtained by its inclusion and secondary components which can be used include carbon powder, graphite, metals, inorganic oxides, silicon etc.

The carbon powder can be formed from an activated carbon and, if the secondary component is an activated carbon powder, preferably a mesoporous activated carbon with a mean pore size in the 1-5 nm range, it is possible to produce an activated carbon monolith where the pore structure is the summation of the pores derived from the sintered phenolic resin component and those derived from the secondary activated carbon. This has the benefit that activated carbons can be used that have extremely high and controlled mesopore structures but are normally only available as fine powders.

In producing these binary materials the pyrolysis conditions for the sintered resin/activated carbon composite structure can be adjusted in line with the expected end use of the product. If the desired product characteristics derive from the activated carbon component the pyrolysis temperature can be reduced to circa 350° C., sufficient to eliminate any extrusion additive e.g. methyl cellulose, from the product macropore structure but without substantially degrading the resin component. If however a higher thermal and/or chemical stability is required the pyrolysis temperature can be increased. The maximum temperature is then defined by the thermal stability of the secondary component.

The production of mesoporous structured carbons is difficult, if not impossible, by other methods as the extreme activation of a complex structure required to give a high mesoporosity would lead to severe degradation and loss of mechanical performance. Conversely the use of conventional binders would lead to the infilling of the pore structure of the activated carbon powder and the resultant loss of porosity.

At temperatures below ˜600° C. the resin component acts as an inert cage structure whilst at higher temperatures the micro pore structure of the phenolic resin derived carbon starts to develop along with an increase in thermal and electrical conductivity. This then provides a route for the production of controlled resistivity carbon structures and also for electrically conducting oxide systems where the oxide is actually a resistor. In this instance the secondary component could be, but is not limited to, amorphous oxides e.g. silica, zeolites, layered clays etc. where there is no simple way of producing complex physical forms. The limitations are that the pyrolysis temperature must be consistent with the thermal stability of the oxide component and carbon component must be stable in the application environment.

The pyrolysed structure can also be further activated using steam or carbon dioxide. For some applications, where a high pyrolysis temperature is required to give the structure good thermal and chemical stability, but the micro pore structure of the phenolic resin derived carbon is not required, or degrades the product properties, the composite structure can be further heat treated to temperatures above 1000° C. This progressively eliminates the resin carbon micropores as the temperature is increased and can be used to further control the porosity of the secondary activated carbon.

Binary materials can also be produced where the secondary component does not add to the porosity of the composite but serves to modify the physical properties, such as electrical conductivity, thermal capacity, magnetic susceptibility etc. of the composite. If graphite powder is used as an additive this results in a substantial reduction in the resistivity of the composite that is a function of the amount of added graphite and the composite pyrolysis temperature and to a lesser extent the size and shape of the graphite component. This provides a route to a complex structure with a unique combination of adsorption and electrical properties that can be used in, for instance, fuel cells, batteries and supercapacitors.

It is also possible to use other conducting powders such as metals e.g. copper, aluminium etc. In these cases a conductivity benefit can be obtained when the processing temperature is such that some sintering of the metallic component occurs. It is preferred that the melting point of the added metal is not exceeded as this can lead to a loss of metal from the composite structure but this is not always the case.

In adsorption processes e.g. the adsorption of volatile organic compounds such as gasoline vapour, the high heat of adsorption of many adsorbates and the low thermal capacity of the activated carbon, can lead to problems with severe bed exotherms that typically limits the adsorbate concentration to a maximum of 1-2% volume. One approach has been to try to increase the thermal capacity of the carbon adsorbent bed by either replacing some of the carbon with an inert high thermal capacity material or using a lower capacity (less activated) carbon. This either results in a significant reduction in bed capacity or has limited benefit. However if a binary material is produced according to the current invention from a high thermal capacity powder and the partially cured resin, it is possible to produce a material with only a slightly reduced volumetric adsorption capacity but a dramatically increased thermal capacity. Such additives can be selected according to their cv characteristics as they do not contribute to the mechanical properties of the formed structure.

Ideal materials include but are not limited to high atomic weight metals such as tungsten etc. The only limiting factors in the selection of the secondary component are the temperature at which the composite will be formed (typically 850-950° C. for an activated carbon structure) and the chemical environment where the finished material will be used. Such materials are expected to have major benefits in areas such as gasoline vapour adsorption where the feed vapour concentration typically exceeds 50% volume.

A further modification is where the secondary component is used to chemically modify the carbon comprising the resin. It has been shown that it is possible to convert carbon to silicon carbide by treating the carbon precursor with either silicon or silicon monoxide. In the first case the carbon is typically covered with the silicon powder. The mixture is either heated to a temperature sufficient to generate a vapour pressure of silicon which diffuses into, and reacts with the carbon structure formed from the resin or where the carbon is impregnated with molten silicon. In the case of SiO, this is usually created in situ by the reaction between silicon and silica or carbon and silica:
C+SiO₂—CO+SiO
Si+SiO₂-2 SiO

Although the direct use of SiO is also possible, the drawback to both methods is that it is necessary for the silicon component to diffuse into the carbon structure which for complex structures, such as monoliths, can require very long processing times.

Using the current invention it is possible to produce a composite structure where the silicon generating agent is already present in the structure. The binary structure can be produced from a mixture of the resin powder with silicon powder, silicon monoxide powder or a mixture of carbon and silicon and silica. In general the routes based on conversion using SiO are preferred as these are net shape processes resulting in essentially no change in the matrix geometry whilst silicon leads to an expansion in the matrix which can cause some problems. It is also possible to simply add silica and use the carbon matrix as the carbon source for the production of the SiO. This however removes carbon from the matrix which may be unacceptable although it can also lead to the production of silicon carbide with an enhanced porosity. However this approach, via direct reaction with the oxide, can be extended to other oxide and carbide materials such as tungsten and molybdenum where vapour phase transport of the oxide is not possible.

The products of the invention can be used for the adsorption of volatile organic compounds such as gasoline vapour in vapour recovery systems, in making electrically conductive porous monolithic carbon structures, e.g. for use in fuel cells as catalysts and catalyst supports, as separation membranes and filters etc.

The invention is illustrated in the following examples.

In the Examples the resin powder was formed from a precursor novolak resin, in a process in which the precursor novolak resin in fine powder form, was mixed with 3 parts by weight of finely powdered hexamethylene tetramine (HEX). The mixed powder was placed in shallow trays and heated to 150° C. to carry out the partial cure.

The resulting resin block was hammer milled to give a powder with a particle size between 100 microns and 2 mm. This powder was then jet milled using a Hozokawa jet mill to give a powder with a mean particle size of 30 microns.

### EXAMPLE 1

### Mesoporous Activated Carbon Powder

This generates a mesoporous monolithic structure.

This resin powder made as above was then dry mixed with the other components shown in table 1. The Polyethylene oxide (PEO) was supplied by Sigma Aldrich. The mesoporous activated carbon was CXV grade supplied by Elf Atochem. The Novolak component was the uncured novolak powder, containing hexamine tetramine as used to produce the cured resin.

TABLE 1

| | 202nov59 | 202dec04 | 202dec11 | 202dec14 |
|---|---|---|---|---|
| Resin | 80 | 60 | 70 | 50 |
| CXV Carbon | 20 | 20 | 30 | 30 |
| Methocell | 6 | 6 | 6 | 6 |
| Novolak | 0 | 20 | 0 | 20 |
| PEO | 1 | 1 | 1 | 1 |
| Water | 93.6 | 91.9 | 95 | 110 |
| % wt CXV est | 0.352 | 0.352 | 0.482 | 0.482 |

After dry mixing the powders, water was gradually added in a Kenwood mixer until a pliable dough was formed. This was then ram extruded into simple rods, tubes and square channel monoliths. The damp extrudates were allowed to dry overnight in ambient air and were then post cured in an air oven at 150° C. to give the “green” materials. These were then carbonised in flowing carbon dioxide at 900° C. The estimated CXV content shown in table 1 is calculated based on a carbon yield of 45% for the cured resin and the novolak components and a zero carbon yield for the methocell and the PEO.

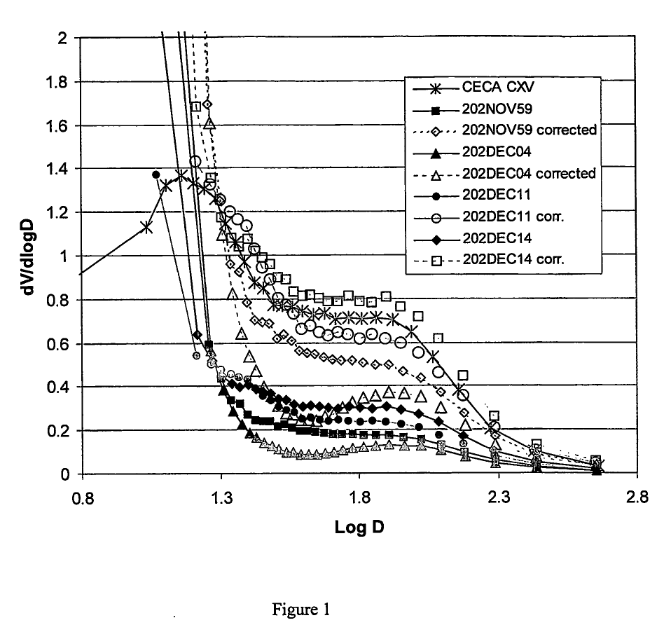

The pore structure characteristics of the resulting carbons are shown in FIG. 1. The filled symbols are the porosity measured using nitrogen adsorption. The open symbols are the corrected pore structure of the CXV component based on the estimated CXV content from table 1. These can be compared with the porosity of the pure CXV component. It can be seen that for the lower CXV content the corrected pore structure falls below that of the pure CXV whilst for the high CXV content material there is reasonable agreement. This suggests that decomposition products created during the pyrolysis process reduce the available porosity at low CXV contents. There is also some evidence that the presence of the novolak component reduces the porosity of the carbonised composite at low CXV contents.

### EXAMPLE 2

In example 2 a further set of materials were produced by the method as described in example 1 but without the addition of the novolak component and with a wider range of CXV contents, from an estimated CXV content in the carbonised material 18.8 to 75.8% weight as shown in table 2. The weight losses during carbonisation of the cured composites are shown in table 2 and vary between 46.8 and 25.8% weight as the CXV content increases. This reflects the absence of any weight loss from the CXV component.

TABLE 2

| | 202dec03 | 203jan44 | | 203jan28 | | 203jan45 | 203jan46 |
|---|---|---|---|---|---|---|---|
| | CXV | 3 | 4 | 5 | 6 | 7 | 8 |
| resin | | 45 | 40 | 35 | 30 | 25 | 20 |
| CXV | | 5 | 10 | 15 | 20 | 25 | 30 |
| MC | | 3 | 3 | 3 | 3 | 3 | 3 |
| PEO | | 0.5 | 0.5 | 0.5 | 0.5 | 0.5 | 0.5 |
| water | | 41.5 | 48.3 | 59.09 | 62.6 | 71.02 | 85.41 |
| resin carbon yield | 0.48 | | | | | | |
| est CXV cont | 100 | 18.8 | 34.2 | 47.2 | 58.1 | 67.6 | 75.8 |
| Carb weight loss | | 46.79 | 42.32 | 39.34 | 28.82 | 40.35 | 25.75 |
| Carbon Density | | 0.818 | 0.725 | 0.631 | 0.566 | 0.519 | 0.473 |

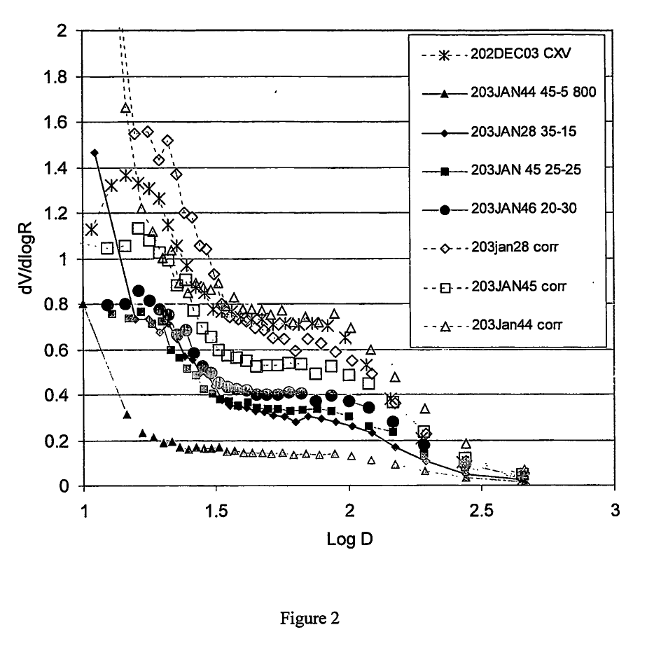

The pore structures of the carbonised materials are shown as the filled symbols in FIG. 2. The pore structures of the carbonised materials are also then corrected to just the CXV component as the open symbols. It can be seen that, within the limits of the accuracy of the estimate of the CXV content, the corrected structures are in good agreement with the observed CXV pore structure. The impact of the underlying porosity of the phenolic resin derived carbon is also apparent at a logD of <1.2.

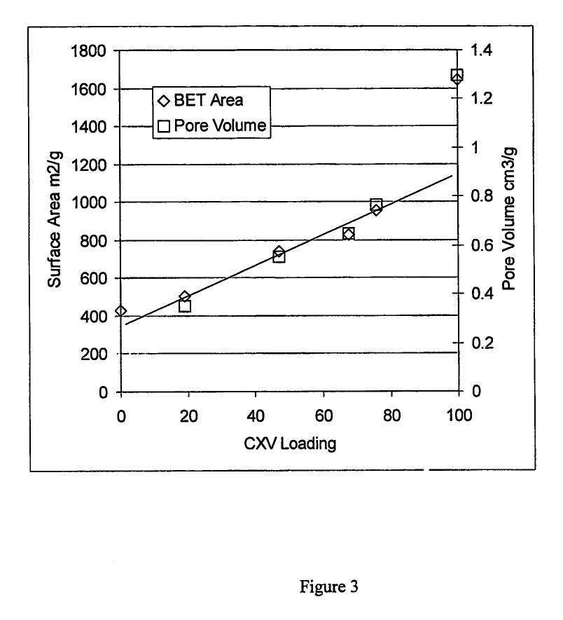

The variation in the BET area and pore volume of these materials as a function of CXV loading is shown in FIG. 3. This shows that the relationship between area/pore volume and carbon loading is approximately linear up to ˜80% CXV content.

### EXAMPLE 3

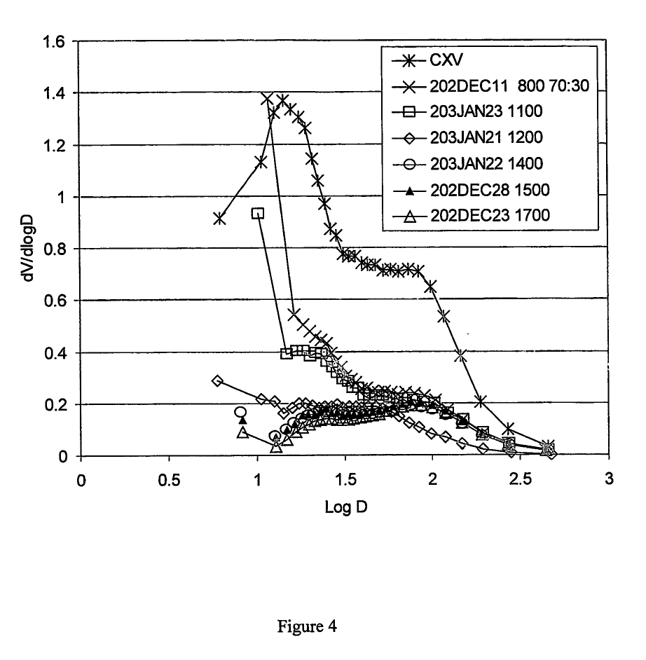

In example 3 the CXV modified carbons (202DEC11), based on the formulation containing 70 parts resin and 30 parts CXV, was subjected to further heat treatment at between 1100 C and 1700 C. It can be seen from FIG. 4 that the large pores, with a mean at Log D=2 (100 angstroms) are largely unaffected by the heat treatment whereas the smaller pores, with a peak logD=1.2 deriving from the CXV, and those below log D=1.2 that derive from the phenolic resin, are significantly reduced at between 1100 and 1200 C. This is in marked contrast to patent U.S. Pat. No. 4,163,775 where much higher temperatures are required to eliminate the smaller pores.

### EXAMPLE 4

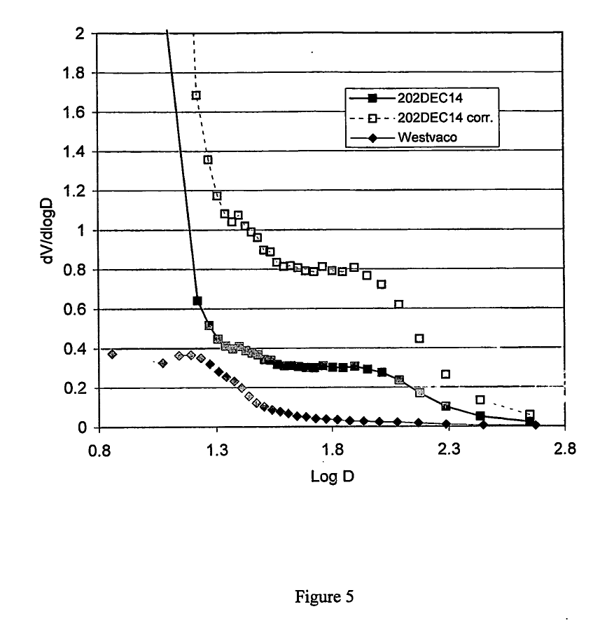

The materials shown in these results can be applied in adsorption applications. Mesoporous carbons are widely used in evaporative emission control devices which are used to limit the escape of gasoline vapour from vehicles during refuelling and hot soak. A well controlled mesopore structure is essential if the carbon is to have both a good adsorption capacity and be easy to regenerate using just cold gas. There is an increasing demand for such materials in the form of monoliths. At present the only available material is a carbon/ceramic composite monolith supplied by Westvaco. The pore structure of the Westvaco monolith is compared with that of the binary composite monolith produced according to the current invention in FIG. 5. It can be seen that the composite carbon structure has a higher porosity in the critical region above log D=1.2. Further improvements should also be possible by selection of the activated carbon component to have a pore peak at log D=1.3.

### EXAMPLE 5

### Creation of High Thermal Capacity Carbon Materials

When VOCs are adsorbed onto activated carbons there is a significant heat production. Whilst some of the heat of adsorption is transferred to the gas stream the majority is transferred to the adsorbate. With activated carbons, where the heat capacity of the carbon is low this can result in a significant temperature rise in the carbon that can reach 100° C. with associated safety implications when the gas stream comprises an organic component in air. There has been a considerable effort in recent years to develop high Cp carbons for use in gasoline vapour control to reduce these temperature excersions but these have only a marginal benefit. We have now shown that if the binary component is a material with a very high Cp, for instance copper, it is possible to generate an activated carbon with a very high density and corresponding Cp.

### EXAMPLE 6

Addition of Graphite to Modify Resistivity

The samples were prepared as in example 1 but fine graphite powder, supplied by Conoco, was used in place of the activated carbon powder. Samples were prepared containing the amounts of the three components (resin, graphite and uncured novolak powder) shown in table 3. These were then extruded into tubes 1.4 mm OD with an ED of 1 mm. After carbonisation at 800° C. in flowing carbon dioxide some of the tubes were further heat treated in helium at temperatures up to 2200° C.

TABLE 3

| Precursor Formulation | | | Carbon Formulation | | |
|---|---|---|---|---|---|
| Resin | Graphite | Novolak | Resin | Graphite | Novolak |
| 83.33% | 0.00% | 16.67% | 83.33% | 0.00% | 16.67% |
| 80.83% | 2.50% | 16.67% | 78.44% | 5.39% | 16.17% |
| 78.33% | 5.00% | 16.67% | 73.82% | 10.47% | 15.71% |
| 72.67% | 10.67% | 16.67% | 64.29% | 20.97% | 14.74% |
| 66.67% | 16.67% | 16.67% | 55.38% | 30.77% | 13.85% |
| 63.33% | 20.00% | 16.67% | 50.89% | 35.71% | 13.39% |
| 43.33% | 40.00% | 16.67% | 29.10% | 59.70% | 11.19% |

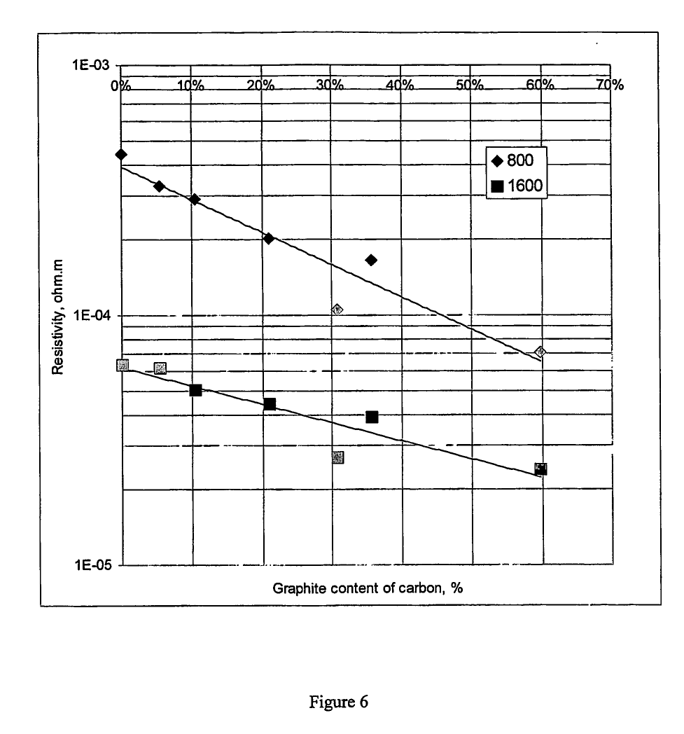

The resistance of the tubes was measured using a four point contact device and converted to resistivity based on the measured tube cross section. The variation in resistivity with graphite content in the final carbon material and heat treatment temperatures of 800° C. and 1600° C. are shown in FIG. 6. The low resistivity of the 1600° C. material reflects the lower resistivity of the phenolic resin component as the resistivity of the graphite component will remain unchanged as a function of heat treatment. Both lines converge toward the limiting resistivity of the graphite component as the graphite content increases although the resistivity of the high graphite binary system is always lower reflecting the greater contribution of the graphite component.

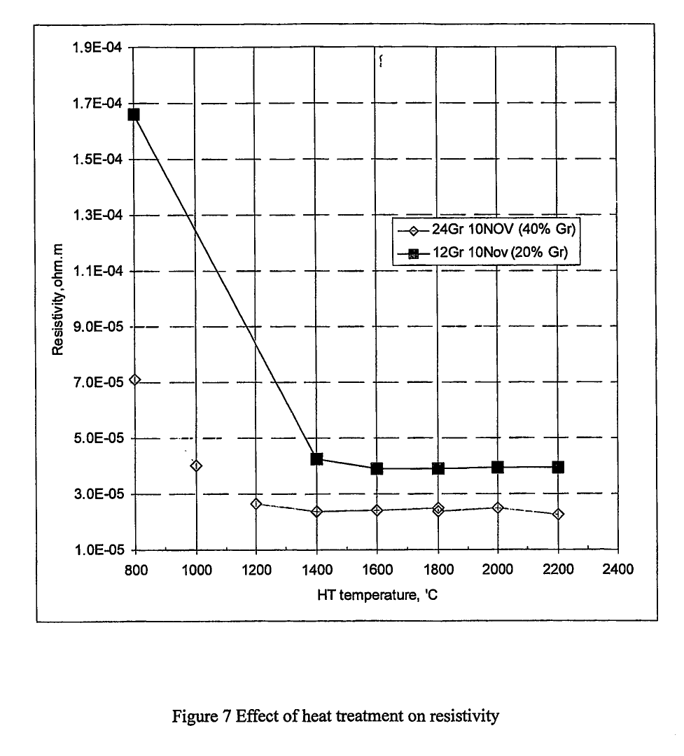

The effect of heat treatment temperature on resistivity is shown in FIG. 7. It can be seen that the systems reach a limiting low resistivity at a heat treatment temperature of approximately 1400° C. irrespective of the graphite content of the composite. This represents the temperature at which the phenolic component reaches its minimum resistivity.

### EXAMPLE 7

### Fuel Cell Applications

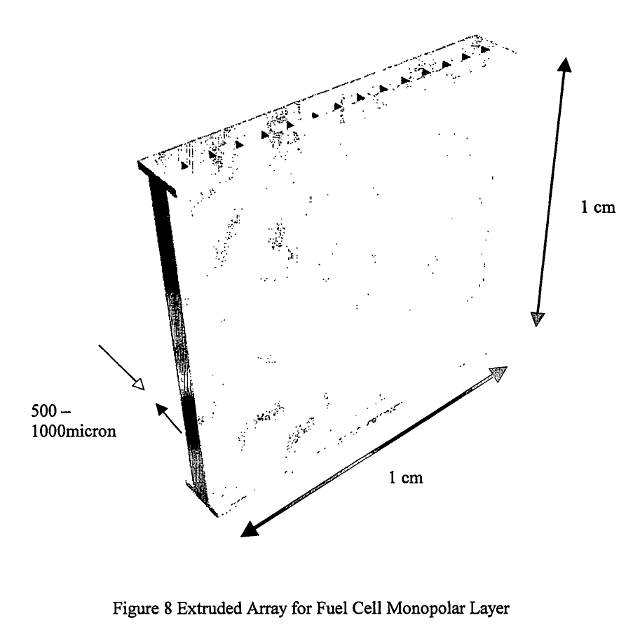

In our co-pending application WO 02/15308 a novel fuel cell structure was described based on hollow carbon fibres. It was shown that for fibres with diameters in the range from around 100 microns to 800 microns and with high electrical conductivity and gas permeability the theoretical power densities significantly exceeded those that could be achieved using conventional bipolar plate designs. However a limitation on the design was the requirement to assemble the cells from arrays of the very small hollow carbon fibres and to achieve the necessary electrical and gas connections. This invention now provides a far simpler way of assembling these high power cells. The ability to independently control the resistivity, porosity and permeability of the binary materials of this invention whilst maintaining the formability of the single component materials in our co-pending applications now allows us to extrude multichannel array to replace the fibre bundle arrays disclosed in WO 02/15308. The structure of one of the layers is shown in FIG. 8 where the channel size is of the order of the inner diameter of the earlier carbon fibres and the overall array thickness is between 500 and 1000 microns.

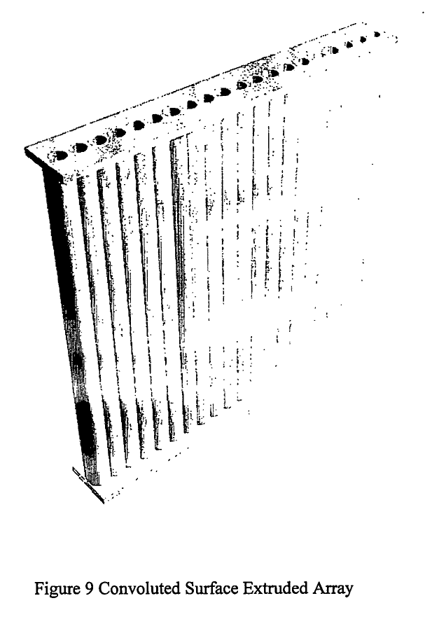

This design allows considerable freedom of action in that the wall thickness of the faces, that control gas diffusion and cell performance, can be minimised whilst maintaining the thickness of the walls between the channels to give acceptable conductivity. It is also possible to convolute the exposed surfaces to increase the accessible surface area as shown in FIG. 9.

### EXAMPLE 8

### Mesoiporous Resin Beads

This generates a mesoporous monolithic structure.

This resin powder made as above was then dry mixed with the other components shown in table 1. After dry mixing the powders, a mixture of 50% water and 50% ethylene glycol pore former was gradually added in a Kenwood mixer until a pliable dough was formed. This was then pressed in a shaped stainless steel mould at 100° C. and 10 kPa to produce a shaped disc. These were then dried at 40° C. overnight and cured at 120° C. This gives a mixture of microporous carbon precursor from the resin and mesoporous carbon precursor from the beads of resin formed from the mixture of resin and the ethylene glycol pore former. These were then carbonised in flowing carbon dioxide at 800° C. to form a mixture of microporous carbon and mesoporous carbon.

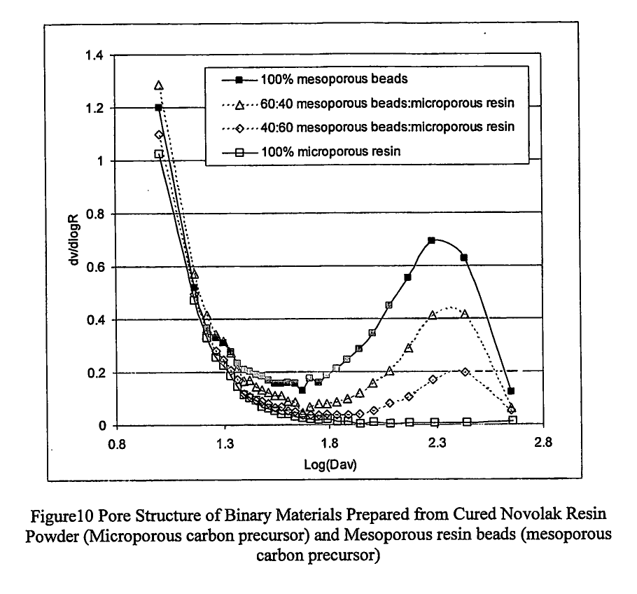

Structures with no mesoporous carbon, mixtures with a microporous to mesoporous carbon weight ratio of 60:40 and 40:60 and with no microporous carbon were formed and the pore structure characteristics of the resulting carbons are shown in FIG. 10. The open squares show the microporous structure that derives from carbonisation of the cured novolak powder whilst the open squares show the mixed micro-mesoporous structure that derives from the pure mesoporous beads. The open triangle and diamonds show the pore structure in the formed, carbonised, monoliths for a 60:40 and 40:60 ratio of the mesoporous and microporous precursors. It can be seen that these represent a simple average of the pore structures of the two components.

1-34. (canceled)

35. A method for producing a porous material which comprises;
(i) partially curing a phenolic resin to a solid;
(ii) grinding said solid to form resin particles;
(iii) mixing said resin particles with particles of a secondary component to form a mixture;
(iv) forming said mixture into a dough;
(v) shaping said dough to obtain a shaped solid product; and
(vi) sintering said shaped solid so as to produce a form-stable sintered product.

36. The method according to claim 35 in which said partially cured phenolic resin is a Novolak resin as herein described.

37. The method according to claim 35 including the step of forming a cage structure of said resin to retain said secondary component without substantially changing the porosity of said secondary component.

38. The method according to claim 35 in which said secondary component comprises at least one of the group comprising a carbon powder, an activated carbon powder, graphite, a metal, an inorganic oxide, a metal oxide, silicon, a carbide, an amorphous oxides a zeolite, a layered clays and silica.

39. The method according to claim 35 in which said secondary component is selected from the group comprising a silicon powder, a silicon monoxide powder, a mixture of carbon or silicon with silica, silicon carbide, a metal carbide, tungsten carbide and molybdenum carbide.

40. The method according to claim 35 in which said secondary component is a mesoporous activated carbon with a mean pore size in the 1-5 nm range.

41. The method according to claim 35 which said secondary component is a mixture of a pore former and a partially cured phenolic resin.

42. The method according to claim 41 in which said pore former is selected from the group comprising ethylene glycol, 1,4-butylene glycol, diethylene glycol, triethylene glycol, gamma-butyrolactone, propylene carbonate, dimethylformamide, N-methyl-2-pyrrolidinone and monoethanolamine.

43. The method according to claim 35 in which said secondary component does not add to the porosity of the composite but serves to modify at least one of other physical properties of the composite.

44. The method according to claim 43 in which said one other physical property which is modified is selected from electrical conductivity, thermal capacity and magnetic susceptibility.

45. The method as claimed in claim 43 in which said secondary component is an electrically conducting material.

46. The method according to claim 43 in said the secondary component is selected from graphite powder and metals.

47. The method according to claim 44 in which said secondary component is selected from copper, tungsten and aluminum.

48. The method according to claim 38 in which said secondary component is formed during the sintering process.

49. The method according to claim 38 in which said secondary component is a carbide formed during the sintering process.

50. The method according to claim 35 including the step of further activating said sintered material by treatment with steam or carbon dioxide.

51. The method according to claim 35 including the step of further treating said porous material by heating said porous material to temperatures above 1000° C.

52. A porous sintered product which comprises a porous monolithic carbon structure which incorporates a secondary component selected from the group comprising carbon powder, activated carbon powder, graphite, metals, inorganic oxides, metal oxides, silicon, mesoporous carbon, amorphous oxides, zeolites, layered clays, silica, metal carbides, non-metallic carbides and mixtures thereof.

53. A porous sintered product which comprises a porous monolithic carbon structure which incorporates a secondary component formed from a mixture of a pore former and a partially cured phenolic resin.

54. The porous sintered product according to claim 53 in which said pore former is selected from the group comprising ethylene glycol, 1,4-butylene glycol, diethylene glycol, triethylene glycol, gamma-butyrolactone, propylene carbonate, dimethylformamide, N-methyl-2-pyrrolidinone and monoethanolamine.

55. The porous sintered product according to claim 52 in which said secondary component does not add to the porosity of the composite but serves to modify at least one of other physical properties of the composite.

56. The porous sintered product according to claim 55 in which said at least one other physical property which is modified comprises electrical conductivity, thermal capacity and/or magnetic susceptibility.

57. The porous sintered product according to claim 56 in which said secondary component is selected from the group comprising a graphite powder and a metal.

58. The porous sintered product according to claim 56 in which said secondary component is selected from the group comprising copper, tungsten and aluminum.

59. The porous sintered product according to claim 52 which comprises a controlled resistivity porous carbon structure incorporating an electrically conducting oxide system as the secondary component.
